(19) United States
(12) Patent Application Publication
(10) Pub. No.: US 2007/0172595 A1
(43) Pub. Date: Jul. 26, 2007

(54) Method for producing a multilayered film f and use thereof

(75) Inventors: Bernd Biallas, Albersloh (DE); Wolfgang Duschek, Munster (DE); Klaus-Dieter Stegemann, Munster (DE); Markus Saedler, Munster (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AKTIENGESELLSCHAFT, Münster (DE)

(21) Appl. No.: 10/598,180

(22) PCT Filed: Mar. 2, 2005
(86) PCT No.: PCT/EP05/51138

§ 371 Date: Aug. 21, 2006

(30) Foreign Application Priority Data
Mar. 5, 2004 (DE) 10 2004 010 787.4

(51) Int. Cl. B05D 3/02; B05D 1/36; C08F 2/46

(52) U.S. Cl. 427/384; 427/402; 427/487

(57) ABSTRACT

Disclosed herein are processes for producing a multilayer sheet as well as uses thereof. In one embodiment, a process for producing a multilayer sheet S by coating a carrier sheet with a pigmented basecoat film, if desired, a second pigmented basecoat film, and a clearcoat. The process comprises: applying a pigmented basecoat material to the carrier sheet and adjusting the film la to a residual volatiles content “x” less than 10% by weight, to give a film 1b. A surface of the film 1b is adjusted to a temperature of <50° C. If desired, a second pigmented basecoat material or the pigmented basecoat material is applied to the film 1b to give a film 2a, and adjusting the film 2a to a residual volatiles content “y” of <10% by weight, based on the basecoat film. If appropriate, the films 1b and 2b are adjusted to a temperature of <50° C. at a surface of the film 2b. A clearcoat material is applied to the film 1b or 2b and the clearcoat film is adjusted to a residual volatiles content “z” of <5% by weight, based on the clearcoat film.

### FIELD OF THE INVENTION

The present invention relates to a new process for producing a multilayer sheet S. The present invention further relates to the use of the sheet S produced by the new process for producing color and/effect coatings on three-dimensional substrates, especially on automobile bodies.

### PRIOR ART

Color and/or effect paint systems on motor vehicle bodies, especially automobile bodies, are nowadays composed preferably of a plurality of coating films which are applied atop one another and have different properties.

By way of example a substrate will have applied to it in succession an electrodeposited electrocoat (EC) as primer coat, a surfacer coat or antistonechip primer coat, a basecoat, and a clearcoat.

Within this system the EC serves in particular to protect the sheet metal from corrosion. It is frequently also referred to by those in the art as the primer coat.

The surfacer coat serves to mask unevennesses in the substrate and by virtue of its elasticity it ensures stonechip resistance. Where appropriate, the surfacer coat may also serve to strengthen the hiding power and to deepen the shade of the paint system.

The basecoat contributes the colors and/or the angle-dependent optical effects. Both the brightness (amount) and the color (through wavelength-specific absorption or through interference) of the reflected light may vary depending on the viewing angle, a phenomenon which is also referred to as brightness flop and/or color flop.

The clearcoat serves to intensify the optical effects and to protect the paint system against mechanical and chemical damage.

Basecoat and clearcoat are often also referred to collectively as the topcoat. For further details refer to Römpp Lexikon Lacke und Druckfarben, Georg Thieme Verlag, Stuttgart, N.Y., 1998, pages 49 and 51, “Automotive finishes”.

Multicoat paint systems of this kind which fully meet all of the requirements imposed on them are frequently also referred to by those in the art as having class A surfaces.

A disadvantage is that these color and/or effect paint systems must often be applied in four separate steps, between each of which the applied films must be flashed off and also, where appropriate, baked, a set of operations which necessitates very complex, three-dimensional coating lines in every automobile plant, for the coating of bodies, and at the premises of every supplier, for the coating of modules and of components for external mounting; which overall is very time-consuming and labor-intensive; and which leads to increased energy costs and capital costs.

It has come to be recognized in the art, moreover, that the application conditions for the basecoat materials in particular may greatly affect the color characteristics and the flop characteristics of the basecoats. In respect of the applied basecoat films the same is true for different drying conditions which have to be set owing to the use of different substrates, such as plastics and metals. In practice these factors necessitate elaborate measures for color matching between components which abut one another directly on a vehicle body.

More recently, in order to avoid these problems from the outset, multilayer color and/or effect films have been proposed for the coating of motor vehicle bodies.

These multilayer color and/or effect films comprise, as is known, a carrier sheet, at least one color and/or effect basecoat, and a clearcoat. They correspond in their construction, accordingly, to the conventional multicoat color and/or effect paint systems.

The multilayer color and/or effect films, however, are intended to be able to be produced under constant conditions and to be applied to any desired substrates to give a substrate- and process-independent color and/or optical effect. Application is to take place by lamination to metals, injection backmolding with thermoplastics, foam backing or compression back-molding. Corresponding processes and sheets are known, for example, from American patents U.S. Pat. Nos. 4,810,540 A, 4,931,324 A or 5,114,789 A, from European patents EP 0 266 109 B 1, EP 0 285 071 B 1, EP 0 352 298 B 1 or EP 0 449 982 B 1, from European patent applications EP 0 050 794 A 1, EP 0 261 815 A 1, EP 0 395 266 A 2, EP 0 754 740 A 2 or EP 0 949 120 A 1 or from international patent applications WO 96/40449 A 1 or WO 03/016095 A 1. The intention of this is to make it possible to respond more effectively to the automobile industry's call for class A surfaces for modules and exterior mounted components for the production of new automobile models.

The existing processes and existing color and/or effect films, however, are incapable of responding fully to this call.

Since the known color and/or effect films are highly stretched when used for coating three-dimensional substrates, especially automobile bodies and modules and exterior mounted components for them, it is necessary for their basecoats and clearcoats to be considerably thicker than conventional basecoats and clearcoats, in order to maintain the assurance of an isotropic color locus, an isotropic flop behavior, and high hiding power of the basecoat, and also the visual and protective functions of the clearcoat, at each and every point. However, increasing the dry film thickness leads to a series of problems during the production and application of the known color and/or effect films, and these problems mount up to form a considerable barrier to the production of class A surfaces.

For instance the known color and/or effect films often cannot be stretched to the extent that would be necessary for the coating of three-dimensional substrates of complex shape. If such stretching is attempted anyway, some or all of the layers may suffer mechanical damage and/or delamination.

The higher dry film thicknesses that are required mean that in the production of the known color and/or effect films a much higher level of effort must be expended in the application of the individual films and in the control of the fraction of volatiles therein.

Excessive wet film thicknesses, for instance, may lead to the resultant basecoat having the wrong shade. Inadequate drying may induce unwanted tackiness in the basecoat. Excessive residual solvent and/or water content and/or excessively rapid removal of solvents and/or water may lead to the development in the basecoat of pinholes and pops from wet film thicknesses of just 20 μm. This results in basecoats having deficient technological properties, particularly as regards adhesion, stonechip resistance, condensation resistance, and color and flop.

Following the wet-on-wet application of basecoat material and clearcoat material there may be unwanted interactions between the wet films. In particular, there may be sinking of the clearcoat material, leading to dulling of the resultant clearcoat. The prior art makes only selective proposals for solving individual problems;
for instance, according to EP 0 395 266 A 1, page 5, lines 47 to 58, the applied basecoat films are to be predried at 71 to 93° C. for from one minute to one hour. The temperature is to be chosen so that the carrier sheet is not distorted or degraded.
According to EP 0 754 740 A 2, page 6, column 9, lines 7 to 11, applied basecoat film is to be predried at 60° C. for 5 minutes.
According to EP 0 266 109 A 2 a self-supporting assembly of basecoat layer and clearcoat layer is to be produced, although no specific drying parameters are stated.

In the clearcoat films as well, high wet film thicknesses may give rise to serious problems, leading to clearcoats having deficient technological properties. In particular, an excessive fraction of volatile constituents may produce
surface defects on the clearcoat surface immediately after drying, which leads to dulling of the clearcoat,
surface defects during the storage of the sheet, as a result of diffusion, for example, leading to waviness in the clearcoat, and/or
surface defects during the final curing of the clearcoat film, leading to pops,
   and can also produce problems on further processing, such as, for example, blistering during thermoforming, and excessive adhesion to the protective sheet. In the case of preliminary drying it is also necessary very strictly to ensure that the drying temperature is not above the softening temperature of the carrier sheet and that there is no thermal crosslinking of the clearcoat film and/or that not too high a molecular weight is built up, since otherwise the problems depicted intensify further.

In this context too the prior art makes only selective proposals toward solving individual problems:
for instance, according to EP 0 395 266 A 1, page 6, lines 39 to 45, the applied clearcoat films are to be cured or predried at 71 to 93° C. for from one minute to one hour. The temperature is to be chosen so that the carrier sheet is not distorted or degraded.
According to EP 0 754 740 A 2, page 6, column 9, lines 11 to 15, the applied clearcoat film is to be flashed off at 23° C. for 5 minutes and cured at 80° C. for 45 minutes.
According to EP 0 266 109 A 2 a self-supporting assembly of basecoat layer and clearcoat layer is to be produced, although no specific drying parameters are stated.

A further problem is posed by disruptions to the flow during application of the second basecoat film and the clearcoat film, these disruptions occurring when the temperature of the conditioned coating film to which the following coating film is applied is too high. Flow defects of this kind lead in particular to visual inhomogeneities in the coated sheet.

### Problem Addressed by the Invention

It is an object of the present invention to provide a new process for producing a multilayer sheet S by coating an optionally pretreated carrier sheet with
1. a pigmented basecoat film,
2. if desired, a second pigmented basecoat film, and
3. a clearcoat film
   that no longer has the aforedescribed disadvantages of the prior art but which instead can be carried out easily and reliably to give—with outstanding reproducibility—multilayer sheets S which can be stored without problems and can be stretched without mechanical damage and/or delamination of any or all the layers, and which, following application to three-dimensional substrates, by preforming of the sheets S and injection backmolding, for example, and preferably a subsequent finishing cure, give coated three-dimenasional substrates, especially coated automobile bodies or modules and exterior mounted components for automobile bodies, which have class A color and/or effect surfaces.

It is intended in particular that the new process should allow basecoat films to be produced in the required high wet film thicknesses without this leading to an incorrect shade and/or to unwanted tackiness of the resultant basecoat. It is also intended that the formation of pops in the basecoat should be avoided. This is intended ultimately to result in basecoats having outstanding technological, properties, particularly in respect of adhesion, stonechip resistance, condensation resistance, shade, and flop.

With the new process, following the wet-on-wet application of basecoat material and clearcoat material, there should no longer be unwanted interactions between the wet films. A particular aim is to avoid the sinking-in of the clearcoat material, since that would lead to dulling of the resultant clearcoat.

With the aid of the new process it should also to be possible to produce the clearcoat films in the required high wet film thicknesses without problems, leading to clearcoats having outstanding technological properties. In particular there should no longer be
surface defects on the clearcoat surface immediately after drying, leading to dulling of the clearcoat,
surface defects during the storage of the sheet, leading to waviness of the clearcoat, and
surface defects during the finishing cure of the clearcoat film, leading to pops.

Additionally there should no longer be any problems associated with further processing, such as, for example, the formation of blisters during thermoforming, and excessive adhesion to the protective sheet.

Moreover, leveling problems occurring when the second basecoat film is applied and when the clearcoat film is applied ought to be avoided.

With the new process the drying temperature ought not to be above the softening temperature of the carrier sheet. With the new process, furthermore, there ought to be no thermal crosslinking of the clearcoat film and/or no development of an excessive molecular weight, so that the deformability and stretchability of the multilayer sheets S continue to be assured.

### The Solution Provided by the Invention

The invention accordingly provides the new process for producing a multilayer sheet S by coating an optionally pretreated carrier sheet with
1. a pigmented basecoat film,
2. if desired, a second pigmented basecoat film, and
3. a clearcoat film
   which involves
a. applying a pigmented basecoat material to the carrier sheet to give a wet basecoat film 1a, which is adjusted to a residual volatiles content of x<10% by weight, based on the basecoat film, to give a conditioned basecoat film 1b,
b. adjusting the assembly comprising carrier sheet and conditioned basecoat film 1b to a temperature of <50° C. on the surface of the basecoat film 1b,
c. if desired, applying a second pigmented basecoat material, or the same pigmented basecoat material for the second time, to the conditioned and temperature-adjusted basecoat film 1b to give a wet basecoat film 2a, which is adjusted to a residual volatiles content of y<10% by weight, based on the basecoat film, to give a conditioned basecoat film 2b,
d. if appropriate, adjusting the assembly comprising carrier sheet and conditioned basecoat films 1b and 2b to a temperature of <50° C. at the surface of the basecoat film 2b,
e. applying a clearcoat material to the conditioned and temperature-adjusted basecoat film 1b or 2b to give a wet clearcoat film 3a, which is adjusted to a residual volatiles content of z<5% by weight, conditioned, deformable clearcoat film 3b which is curable thermally and/or with actinic radiation.

The new process for producing a multilayer sheet S is referred to below as the “process of the invention”.

The invention further provides for the new use of the multilayer sheet S produced by means of the process of the invention for producing color and/or effect films which serve for the coating of the three-dimensional substrates, this use being referred to below as “use in accordance with the invention”.

### The Advantages of the Solution Provided by the Invention

In the light of the prior art it was surprising and unforeseeable for the skilled worker that the object on which the present invention was based could be achieved by means of the process of the invention and of use in accordance with the invention.

In particular it was surprising that the process of the invention no longer had the disadvantages of the prior art but instead could be carried out easily and reliably and gave—with outstanding reproducibility—multilayer sheets S which could be stored without problems and stretched without mechanical damage and/or delamination of any or all the layers, and which, following application to three-dimensional substrates, by preforming of the sheets S and injection backmolding, for example, and preferably a subsequent finishing cure, gave coated three-dimensional substrates, especially coated automobile bodies or modules and exterior mounted components for automobile bodies, having class A color and/or effect surfaces.

The process of the invention made it possible in particular to produce basecoat films in the required high wet film thicknesses without this leading to an incorrect shade and/or an unwanted tackiness in the resulting basecoat. It was also possible to avoid the development of pops in the basecoat. This resulted ultimately in basecoats having outstanding technological properties, particularly in respect of adhesion, stonechip resistance, condensation resistance, shade, and flop.

With the process of the invention, following the wet-on-wet application of basecoat material and clearcoat material, there were no longer any unwanted interactions between the wet films. In particular it was possible to avoid the sinking-in of the clearcoat material and hence the dulling of the resultant clearcoat.

By means of the process of the invention it was also possible to produce the clearcoat films without problems in the required high wet film thicknesses, so giving clearcoats having outstanding technological properties. In particular there were
no surface defects on the clearcoat surface immediately after drying, leading to dulling of the clearcoat,
no surface defects during the storage of the sheet, leading to waviness of the clearcoat, and
no surface defects during the finishing cure of the clearcoat film, leading to pops
   any more. In addition there were no longer any problems, such as, for example, the development of blisters during thermoforming, or excessive adhesion to the protective sheet, in the course of further processing.

By means of the process of the invention it was additionally possible to avoid leveling problems during application of the second basecoat and during application of the clearcoat film.

With the process of the invention it was reliably ensured that the drying temperature was not above the softening temperature of the carrier sheet. Moreover, with the new process, there was no thermal crosslinking of the clearcoat film and/or no development of an excessive molecular weight, so that the deformability and stretchability of the multilayer sheets S continued to be assured.

### DETAILED DESCRIPTION OF THE INVENTION

The Materials Used in the Process of the Invention

For the process of the invention it is possible to use all conventional carrier sheets, protective sheets, and adhesion coats, such as are described in, for example, the American patents U.S. Pat. Nos. 4,810,540 A, 4,931,324 A or 5,114,789 A, the European patents EP 0 266 109 B 1, EP 0 285 071 B 1, EP 0 352 298 B 1 or EP 0 449 982 B 1, the European patent applications EP 0 050 794 A 1, EP 0 261 815 A 1, EP 0 395 266 A 2, EP 0 754 740 A2 or EP 0 949 120 A 1, or the international patent applications WO 96/40449 A 1 or WO 03/016095 A 1. The carrier sheets may be pigmented or unpigmented. Use is made in particular of the carrier sheets described by WO 03/016095 A 1, page 16, line 19, to page 17, line 3. The pigmented carrier sheets may be adapted in terms of their shade to the basecoats that will subsequently be present on them. The surface of the carrier sheets that is to be coated can be pretreated chemically and/or physically in conventional manner prior to the application of the coating materials. The protective sheets which are applied to the carrier sheet/coating film composite are compatible with the clearcoat films 3b.

As pigmented basecoat materials for producing the pigmented basecoat films 1a and also, where appropriate, 2a it is possible to use all customary and known basecoat materials, especially aqueous basecoat materials, such as are described in, for example, WO 03/016095 A 1, page 10, line 15, to page 14, line 22. With further preference use is made of aqueous basecoat materials such as are described in EP 0 754 740 and in U.S. Pat. No. 5,030,514 A. Different basecoat materials or the same basecoat material can be used for producing the pigmented basecoat films 1a and, where appropriate, 2a.

As clearcoat materials for producing the clearcoat films 3a it is possible to use all customary and known, liquid clearcoat materials which are curable thermally and/or with actinic radiation, such as are described in, for example, WO 03/016095 A1, page 25, line 7, to page 27, line 11. It is preferred to use clearcoat materials which are given a finishing cure with UV radiation and are described in, for example, DE 199 17 965 A1.

By actinic radiation is meant, here and below, electromagnetic radiation, such as near infrared (NIR), visible light, UV radiation, X-rays, and gamma radiation, especially UV radiation, and corpuscular radiation, such as electron beams, alpha radiation, beta radiation, proton beams, and neutron beams, especially electron beams.

The Methods and Apparatus Used in Carrying Out the Process of the Invention

For the process of the invention it is preferred to use apparatus which allows the continuous coating of beltlike carrier sheets with basecoat and clearcoat materials. The application apparatus and the carrier sheets are in relative motion with respect to one another. In particular the application apparatus is stationary and the carrier sheets are guided past it in continuous motion. The application apparatus can be moved to and fro transverse to the direction of motion of the carrier sheets.

The basecoat material is preferably applied by means of a directed application method. Examples of suitable directed application methods are known from WO 03/016095 A 1, page 15, lines 6 to 19. Knife coaters, casting apparatus, and rollers are used in particular.

If the pigmentation necessitates a certain uniformity of distribution and/or if its purpose is to set a very specific shade and/or optical effect, then the basecoat film 2a is applied to the conditioned basecoat film 1b. In this case the basecoat material is preferably applied by means of an undirected application method which in the resultant basecoat film 2a and, respectively, 2b does not give rise to any arrangement of the pigments in a preferential direction; in other words, in the basecoat film 2a and hence also in the conditioned basecoat film 2b the pigments are in isotropic distribution. Examples of suitable undirected application methods and apparatus therefor are known from WO 03/016095 A 1, page 20, line 4, to page 23, line 25. In particular, pneumatic or electrostatic spraying apparatus is used, as described in WO 03/016095 A 1, page 20, line 4, to page 23, line 25.

In order in the eventual basecoat to attain the color and/or flop effect which is necessary for adaptation to a defined shade original it is also possible for the basecoat film 2a to be applied by means of high-speed electrostatic rotation or by means of electrostatically assisted pneumatic atomization.

In that the case the basecoat film 1a can be applied by means of one of the directed application methods described above that produces an arrangement of the pigments in a preferential direction, i.e., an anisotropic distribution of the pigments, in the resultant basecoat film 1a and, respectively, 1b.

If a carrier sheet is used which corresponds substantially or entirely in its coloring to the target color of the eventual basecoat it is possible as the basecoat film 1a merely to apply a nonhiding, color and/or effect film by means of electrostatically assisted pneumatic atomization or pneumatic high-speed electrostatic rotation.

The liquid clearcoat materials can be applied by means of the directed and undirected application methods described above. Preferably the clearcoat materials are applied by directed application methods, very preferably using extrusion coaters. If the liquid clearcoat materials are curable (solely or jointly) by actinic radiation then they are applied and processed further in the absence of actinic radiation.

For the conditioning of the wet basecoat films 1a and, where appropriate, 2a and also of the wet clearcoat films 2a it is preferred to use thermal and/or convection methods, employing conventional apparatus, such as through-type ovens, radiant NIR and IR heaters, fans, and blower tunnels. Combinations of such apparatus are also possible.

The assemblies which result in the course of the process of the invention, comprising carrier sheet and basecoat film 1b, or carrier sheet, basecoat film 1b, and basecoat film 2b, can be wound up prior to the application of the next film, stored, transported, and supplied to another application apparatus, in which they are coated with said next film. For this purpose the composites can be lined with protective sheet, which is removed again before the next film is applied.

Preferably, however, the process of the invention is carried out in a continuous installation containing all of the necessary application and conditioning apparatus. Said continuous installation further comprises conventional apparatus for supplying the basecoat and clearcoat materials to the application apparatus; unwinders for the carrier sheets and protective sheets, and winders for the multilayer sheets S; drive apparatus for the motion of the sheets and, where appropriate, of the application apparatus; suction exhaust apparatus for the volatiles; cooling fans and/or chill rolls for adjusting the surface temperature of the conditioned coating films; measurement and control apparatus; and, where appropriate, apparatus for shielding from actinic radiation.

The Implementation of the Process of the Invention

Process Step a.

In step a. of the process a pigmented basecoat material is applied to the carrier sheet to give a wet basecoat film 1a, which is adjusted preferably by heating and/or convection to a residual volatiles content of x<10% by weight, preferably <7% by weight, more preferably <5% by weight, based in each case on the basecoat films, to give a conditioned basecoat film 1b. Application takes place under booth conditions, such as are known from, for example, OEM production line finishing.

The wet basecoat film 1a preferably has a film thickness of from 50 to 150 μm. Here and below, “volatiles” are all those constituents of the basecoat materials and also of the clearcoat materials which, after the basecoat films and clearcoat films produced from the basecoat materials and clearcoat materials have been cured, do not remain in the resultant basecoats and clearcoats. Volatiles comprise, in particular, organic solvents and water.

Prior to conditioning the basecoat film 1a is preferably flashed off for from 1 to 6 minutes, more preferably from 2 to 4 minutes. In the course of flashing off, it, is particularly preferred to set the temperature, humidity, and airspeed prevailing in the application zone. If drying is preceded by flashing off, then drying takes place in a separate drying zone.

In the conditioning of the basecoat film 1a it is preferred to employ the following drying kinetics:
in the first drying section an average drying rate of 10 to 40% by weight/min is employed, based on the total volatiles content of the applied basecoat film, until a residual volatiles content of x=12 to 30% by weight, based on the basecoat film, is reached, and
in the last drying section an average drying rate of 1 to 6% by weight/min is employed, based on the total volatiles content of the applied basecoat film, until a residual volatiles content of x<10% by weight, more preferably <7% by weight, in particular <5% by weight, based in each case on the basecoat film, is reached.

The conditioning of the basecoat film 1a is carried out preferably at temperatures from 30 to 100° C. A humidity of from 3 to 15 g/kg is preferably set. With particularly preference the conditioning period is from 1 to 10 minutes. The airspeeds are in particular from 0.2 to 15 m/s.

The resulting conditioned basecoat film 1b preferably has a film thickness of from 1.0 to 30 μm.

Process Step b.

In step b. of the process the resulting assembly, comprising carrier sheet and conditioned basecoat film 1b, is adjusted to a temperature of <50° C., in particular <35° C., at the surface of the basecoat film 1b.

Process Step c.

In the optional step c. of the process a second pigmented basecoat material or the same basecoat, material for the second time is applied to the conditioned and temperature-adjusted basecoat film 1b to give a wet basecoat film 2a, which is adjusted preferably by heating and/or convection to a residual volatiles content of y<10% by weight, preferably <7% by weight, more preferably <5% by weight, based in each case on the basecoat film, to give a conditioned basecoat film 2b.

The wet basecoat film 2a preferably has a film thickness of from 25 to 100 μm.

Prior to conditioning the basecoat film 2a is preferably flashed off for from 1 to 6 minutes, more preferably from 3 to 5 minutes. In the course of flashing off, it is particularly preferred to set the temperature, humidity, and airspeed prevailing in the application zone. If drying is preceded by flashing off, then drying takes place in a separate drying zone.

In the conditioning of the basecoat film 2a it is preferred to employ the following drying kinetics:
in the first drying section an average drying rate of 10 to 40% by weight/min is employed, based on the total volatiles content of the applied basecoat film, until a residual volatiles content of y=12 to 30% by weight, based on the basecoat film, is reached, and
in the last drying section an average drying rate of 1.5 to 4% by weight/min is employed, based on the total volatiles content of the applied basecoat film, until a residual volatiles content of x<10% by weight, more preferably <7% by weight, in particular <5% by weight, based in each case on the basecoat film, is reached.

The conditioning of the basecoat film 2a is carried out preferably at temperatures from 30 to 100° C. A humidity of from 3 to 15 g/kg is preferably set. With particularly preference the conditioning period is from 1 to 10 minutes. The airspeeds are in particular from 0.2 to 15 m/s.

The resulting conditioned basecoat film 2b preferably has a film thickness of from 5 to 20 μm.

Preferably the total film thickness of the basecoat films 1b and 2b is from 15 to 50 μm.

Process Step d.

For the purposes of the process of the invention step d. of the process is carried out if there is a second basecoat film 2b. In step d. of the process the resulting assembly, comprising carrier sheet and conditioned basecoat films 1b and 2b, is adjusted to a temperature of <50° C., in particular <35° C., at the surface of the basecoat film 2b.

Process Step e.

In step e. of the process a clearcoat material is applied to the conditioned and temperature-adjusted basecoat film 1b or 2b to give a wet clearcoat film 3a, which is adjusted by heating and/or convection to a residual volatiles content of z<5% by weight, preferably <3% by weight, based on the clearcoat film, to give a conditioned deformable clearcoat film 3b which is curable thermally and/or with actinic radiation. The wet clearcoat film 3a preferably has a film thickness of from 80 to 160 μm.

Prior to conditioning the clearcoat film 3a is preferably flashed off for from 2 to 8 minutes, more preferably from 5 to 7 minutes. In the course of flashing off, it is particularly preferred to set the temperature, humidity, and airspeed prevailing in the application zone. If drying is preceded by flashing off, then drying takes place in a separate drying zone.

In the conditioning of the clearcoat film 3a it is preferred to employ the following drying kinetics:
in the first drying section an average drying rate of 10 to 30% by weight/min is employed, based on the total volatiles content of the applied clearcoat film, until a residual volatiles content of z=10 to 15% by weight, based on the clearcoat film, is reached, and
in the last drying section an average drying rate of 0.5 to 3% by weight/min is employed, based on the total volatiles content of the applied clearcoat film, until a residual volatiles content of z<7% by weight, more preferably <5% by weight, in particular <3% by weight, based in each case on the clearcoat film, is reached.

The clearcoat film 3a preferably conditioned for at oven temperatures from 80 to 140° C., in particular from 90 to 120° C.

The film thickness of the conditioned clearcoat film 3b is preferably from 40 to 80 μm.

Step e. of the process results in the multilayer sheet S, and so the process of the invention is essentially concluded. It is possible, however, for further appropriate process steps to follow.

Process Step f.

In the optional step f. of the process the resulting assembly, comprising carrier sheet, conditioned basecoat film 1b and, if appropriate, conditioned basecoat film 2b, and conditioned clearcoat film 3b (=multilayer sheet S), is adjusted to a temperature of <50° C., in particular <35° C., at the surface of the clearcoat film 3b.

Process Step g.

In the optional step g. of the process the multilayer sheet S has applied to it a conventional protective sheet.

Process Step h.

In the optional step h. of the process the multilayer sheet S is wound to form a roll or is cut into smaller sections. The roll can be stored and/or transported until the multilayer sheet is used further.

Use in Accordance with the Invention

The multilayer sheets S produced by means of the process of the invention are outstandingly suitable for producing color and/or effect films. These films in turn are outstandingly suitable for coating substrates, preferably three-dimensional substrates, especially automobile bodies and modules or exterior mounting components therefor. For that purpose the multilayer sheets S are joined to the substrates. They are stretched before, during or after their joining. After they have been joined with the substrates the multilayer sheets S are preferably converted by thermal curing and/or curing with actinic radiation into the color and/or effect films. Curing is preferably carried out as described in WO 03/016095 A 1, page 27, line 19, to page 28, line 24.

The sheets S of the invention, after they have been preformed, injection backmolded, and then given a finishing cure, particularly provide coated three-dimensional substrates, especially coated automobile bodies or modules and exterior mounted components for automobile bodies, having class A color and/or effect surfaces.

### EXAMPLES 1 TO 3

The Production of the Multilayer Sheets S1 to S3

The multilayer sheet S1 of example 1 was produced using the commercial 800 μm carrier sheet with dark gray pigmentation and based on Luran® from BASF Aktiengesellschaft and also the commercial Brillantsilber [silver] basecoat material from BASF Coatings AG (with a nonvolatiles content of about 20% by weight, based on the coating material).

The multilayer sheet S2 of example 2 was produced using the commercial 800 μm carrier sheet with light gray pigmentation and based on Luran® from BASF Aktiengesellschaft and also the commercial Travertinbeige [beige] basecoat material, from BASF Coatings AG (with a nonvolatiles content of about 20% by weight, based on the coating material).

The multilayer sheet S3 of example 3 was produced using the commercial 800 μm carrier sheet with black pigmentation and based on Luran® from BASF Aktiengesellschaft and also the commercial Obsidianschwarz [black] basecoat material from BASF Coatings AG (with a nonvolatiles content of about 20% by weight, based on the coating material).

For examples 1 to 3 a clearcoat material as per example 1 of DE 199 17 965 A1 (with a nonvolatiles content of about 50% by weight, based on the coating material) was used.

The multilayer sheets S1 to S3 were produced in accordance with the following general instructions.

General Production Instructions:

The surface of the carrier sheet to be coated was subjected to a corona pretreatment at 0.5 kilowatts.

The basecoat material was applied to the carrier sheet using a box-type bar coater with a width of 37 cm at a belt speed of 0.5 m/min. Application was carried out with a weak airflow of 0.2 m/s, a constant temperature of 21±1° C., and a constant relative humidity of 65±5%. The film thickness of the resulting wet basecoat film 1a was 100 μm.

The wet basecoat film 1a was flashed off for 3 minutes under these conditions.

In the first drying section the basecoat film 1a was dried for 3 minutes with an average drying rate of 29% by weight/min, based on the total volatiles content of the applied basecoat film, until the residual volatiles content was x=13% by weight, based on the basecoat film. In the last drying section the basecoat film 1a was dried for 3 minutes with an average drying rate of 3% by weight/min, based on the total volatiles content of the applied basecoat film, until the residual volatiles content was x=4% by weight, based on the basecoat film.

The air temperature was 90° C., the humidity was 10 g/min, and the airspeeds were 10 m/s.

The resulting conditioned basecoat film 1b, approximately 20 μm thick, was adjusted using chill rolls to a surface temperature <30° C.

The same basecoat material was applied to the conditioned and temperature-adjusted basecoat film 1b under the following conditions, using a system for pneumatic spray application:
outflow rate: 100 ml/min;
air pressures: atomizer air: 2.5 bar; horn air: 2.5 bar;
speed of movement of the nozzles: sufficient to produce a spray jet overlap of 60%;
nozzle/sheet distance: 30 cm.

Application was carried out with a weak airflow of 0.5 m/s (with the flow striking the sheet perpendicularly), a constant temperature of 21±1° C., and a constant relative humidity of 65±5%. The film thickness of the resulting wet basecoat film 2a was 50±2 μm. The basecoat film 2a was flashed off for 3 minutes under these conditions.

In the first drying section the basecoat film 2a was dried for 3 minutes with an average drying rate of 29% by weight/min, based on the total volatiles content of the applied basecoat film, until the residual volatiles content was y=13% by weight, based on the basecoat film.

In the last drying section the basecoat film 2a was dried for 3 minutes with an average drying rate of 3% by weight/min, based on the total volatiles content of the applied basecoat film, until the residual volatiles content was y=4% by weight, based on the basecoat film.

The air temperature was 90° C., the humidity was 10 g/min, and the airspeeds were 10 m/s.

The resulting conditioned basecoat film 2b, approximately 10 μm thick, was adjusted using chill rolls to a surface temperature <30° C.

The clearcoat material was applied to the conditioned and temperature-adjusted basecoat film 2b using a box-type bar coater with a width of 37 cm. Application was carried out with a weak airflow of 0.2 m/s, a constant temperature of 21±1° C., and a constant relative humidity of 65±5%. The film thickness of the resulting wet clearcoat film 3a was 120 μm. It was flashed off for 6 minutes under the stated conditions.

In the first drying section the clearcoat film 3a was dried for 5 minutes with an average drying rate of 17.5% by weight/min, based on the total volatiles content of the applied clearcoat film, until the residual volatiles content was z=12.5% by weight, based on the clearcoat film.

In the last drying section the clearcoat film 3a was dried for 10 minutes with an average drying rate of 1% by weight/min, based on the total volatiles content of the applied clearcoat film, until the residual volatiles content was z=2.5% by weight, based on the clearcoat film.

The air temperature in the oven was 119° C. for all drying stages.

The resulting conditioned clearcoat film 3b, 60 μm thick, was adjusted using chill rolls to a surface temperature <30° C. and was covered with a protective sheet of polypropylene.

The resulting multilayer sheet S was wound to form a roll and was stored in that form until its further use.

The multilayer sheets S1 to S3 were able to be wound to form rolls without problems and to be stored and/or transported before their subsequent use, without detriment to their outstanding performance properties, in particular their dimensional stability on the one hand and their deformability on the other. There were no problems in cutting them into sections. It was possible to weld the sections into airtight and moisturetight films and to store them in that form for months.

The multilayer sheets S1 to S3 were outstandingly suitable for producing class A surfaces on automobile bodies and for producing modules and exterior mounted components having class A surfaces.

1. A process for producing a multilayer sheet S by coating an optionally pretreated carrier sheet with
pigmented basecoat film,
if desired, a second pigmented basecoat film, and
a clearcoat film, the process comprising:
a. applying a pigmented basecoat material to the carrier sheet to give a wet basecoat film 1a, and adjusting the basecoat film 1a to a residual volatiles content “x” of less than 10% by weight, based on the basecoat film, to give a conditioned basecoat film 1b,
b. adusting a surface of the conditioned basecoat film 1b to a temperature of less than 50° C. to give a tempature-adjusted basedcoat film 1b
c. if desired, applying a second pigmented basecoat material or the pigmented basecoat material to the temperature-adjusted basecoat film 1b to give a wet basecoat film 2a, and adusting the basecoat film 2a to a residual volatiles content “y” of less than 10% by weight, based on the basecoat film, to give a conditioned basecoat film 2b,
d. if appropriate, adjusting the conditioned basecoat films 1b and 2b to a temperature of less than 50° C. at a surface of the basecoat film 2b to give a temperature-adjusted basedcoat film 2b,
e. applying a clearcoat material to the temperature-adjusted basecoat film 1b or 2b to give a wet clearcoat film 3a, adjusting the clearcoat film 3a to a residual volatiles content “z” of less than 5% by weight, based on the clearcoat film, to give a conditioned, deformable clearcoat film 3b, and curing the conditioned, deformable clearcoat film 3b thermally and/or with actinic radiation.

2. The process as claimed in claim 1, wherein the residual volatiles content in steps a., c. and/or e. is adjusted by heating and/or convection.

3. The process as claimed in claim 1, step a. further comprising
in the first drying section, employing an average drying rate of 10 to 40% by weight/min, based on the total volatiles content of the applied basecoat film, until the residual volatiles content x is 12 to 30% by weight, based on the basecoat film, and
in the last drying section, employing an average drying rate of 1 to 6% by weight/min, based on the total volatiles content of the applied basecoat film, until the residual volatiles content of x is less than 10% by weight, based in each case on the basecoat film.

4. The process as claimed in claim 1, comprising adusting the basecoat film 1b in step b. temperature of less than 35° C. at the basecoat film 1b surface.

5. The process as claimed in claim 1, wherein step c. further comprises
in the first drying section, employing an average drying rate of 10 to 40% by weight/min, based on the total volatiles content of the applied basecoat film, until the residual volatiles content y is 12 to 30% by weight, based on the basecoat film, and
in the last drying section, employing an average drying rate of 1.5 to 4% by weight/min, based on the total volatiles content of the applied basecoat film, until the residual volatiles content of x is less than 10% by weight.

6. The process as claimed in claim 1, comprising adjusting the basecoat film 2b in step d to a temperature of less than 35° C. at its surface 2b.

7. The process as claimed in claim 1, wherein step e further comprises
in the first drying section, employing an average drying rate of 10 to 30% by weight/min, based on the total volatiles content of the applied clearcoat film, until the residual volatiles content z is 10 to 15% by weight, based on the clearcoat film, and
in the last drying section, employing an average drying rate of 0.5 to 3% by weight/min, based on the total volatiles content of the applied clearcoat film, until the residual volatiles content z is less than 7% by weight, based in each case on the clearcoat film.

8. The process as claimed in claim 1, further comprising, in a step f., adjusting a surface of the clearcoat film 3b to a temperature of less than 50° C.

9. The process as claimed in claim 1, further comprising covering a surface of the clearcoat film 3b with a protective sheet in a step g.

10. The process as claimed in claim 1, wherein applying the basecoat material in step a. comprises applying by means of a continuous method.

11. The process as claimed in claim 1, wherein applying the basecoat material in step c. comprises applying by means of a continuous method.

12. The process as claimed in claim 1, wherein applying the clearcoat material in step e. comprises applying by means of a continuous method.

13. The process as claimed in claim 1, wherein applying the basecoat material in step a. comprises applying by means of a directed application method.

14. The process as claimed in claim 1, wherein applying the basecoat material in step c. comprises applying by means of an undirected application method.

15. The process as claimed in claim 1, further comprising wherein a free side of the carrier sheet has been covered with an adhesion coat.

16. The use of the multilayer sheets S produced by the process as claimed in claim 1 for producing color and/or effect films.

17. The use as claimed in claim 16, wherein the color and/or effect films serve for the coating of substrates.

18. The use as claimed in claim 16, further comprising, after the multilayer sheets S have been joined with substrates, converting the multilayer sheets S into color and/or effect coatings by thermal curing and/or curing with actinic radiation.

19. The use as claimed in claim 18, further comprising stretching the multilayer sheets S before, during or after their joining to the substrates.

20. The use as claimed in claim 17, wherein the substrates are selected from the group consisting of automobile bodies, modules, and exterior mounted components therefore.

21. The process as claimed in claim 3, comprising, in the last drying section, employing an average drying rate of 1 to 6% by weight/min, based on the total volatiles content of the applied basecoat film, until the residual volatiles content x is less than 7% by weight.

22. The process as claimed in claim 21, comprising, in the last drying section, employing an average drying rate of 1 to 6% by weightmin, based on the total volatiles content of the applied basecoat film, until the residual volatiles content x is less than 5% by weight, based in each case on the basecoat film.

23. The process as claimed in claim 7, comprising, in the last drying section, employing an average drying rate of 0.5 to 3% by weight/min, based on the total volatiles content of the applied clearcoat film, until the residual volatiles content z is less than 5% by weight.

24. The process as claimed in claim 23, comprising, in the last drying section, employing an average drying rate of 0.5 to 3% by weight/min, based on the total volatiles content of the applied clearcoat film, until the residual volatiles content z is less than 3% by weight.
